(19) United States
(12) Patent Application Publication
(10) Pub. No.: US 2025/0258102 A1
(43) Pub. Date: Aug. 14, 2025

(54) Method to Determine the Mass of Particles Collected on a Collection Membrane

(71) Applicant: Stat Peel AG, Glarus (CH)

(72) Inventors: Margherita Orazietti, Zürich (CH); Mihaela Manole, Richterswil (CH); Ruedi Bieri, Glarus (CH)

(21) Appl. No.: 19/169,439

(22) Filed: Apr. 3, 2025

Related U.S. Application Data
(63) Continuation of application No. 18/021,600, filed on Feb. 16, 2023, now abandoned.

(30) Foreign Application Priority Data
Aug. 17, 2020 (EP) 20191271.4

(51) Int. Cl. G01N 21/65; G01N 1/28; G01N 15/10; G01N 21/31

(52) U.S. Cl. CPC G01N 21/65; G01N 1/2813; G01N 15/10; G01N 21/314; G01N 2015/1021

(57) ABSTRACT

A method to determine a mass of particles collected on a collection membrane having a first surface and a second surface. The particles to be analysed are deposited on the first surface. In a first step, the particles of the first surface are scanned with a Raman spectrometer and a preliminary Raman signal is collected. In a second step, at least one additional physical property of the particles is determined. In a third step, a correction factor is calculated based on the additional physical property. In a fourth step, a final Raman signal is calculated based on the correction factor and the preliminary Raman signal. In a fifth step the actual mass of the particles is determined based on the final Raman signal.

### CROSS REFERENCE TO RELATED APPLICATIONS

This application is a continuation application of U.S. patent application Ser. No. 18/021,600 filed Jul. 5, 2021, which is the United States national phase of International Patent Application No. PCT/EP2021/068485 filed Jul. 5, 2021, which claims priority to European Patent Application No. 20191271.4 filed Aug. 17, 2020, the disclosures of which are hereby incorporated by reference in their entireties.

### BACKGROUND OF THE INVENTION

### Field of the Invention

The present invention relates to a method to determine the mass of particles collected on a collection membrane.

### Description of Related Art

Today's advances in man-made nanomaterials pose new and unprecedented risks to employees along the whole value chain. Especially airborne, inhalable fiber-shaped nanomaterials like carbon nanotubes (CNTs), carbon nanofibers (CNFs) and graphene nanoplatelets (GNPs) pose asbestos-like health risks when inhaled.

WO 2016/150991 of the applicant discloses a device as well as a system in order to determine the long-term exposure to nanoparticles, in particular small oblong nanoparticles, such as carbon nanotubes or the like.

The device as well as the system according to WO 2016/150991 provide very good measurement results. However, in certain applications the particles and their behavior once collected on the surface of the membrane may lead to an inaccurate result. For example, particles with high absorption, particles having a larger size or aggregated particles may lead to a loss of the excitation light of the spectrometer and this may cause inaccuracy in the determination of the mass.

### SUMMARY OF THE INVENTION

It is therefore an object of the present invention to provide a method and/or a device which overcomes the drawbacks of prior art. In particular it is an object of the present invention to provide a method and/or a device, which has an enhanced accuracy of measurement, in particular for particles which influence the measurement result. Such particles are for example particles with a high absorption, particles having a larger size or aggregated particles.

This object is solved by the method described herein. The method serves to determine the mass of particles collected on a collection membrane having a first surface and a second surface, whereby the particles to be analysed are deposited on the first surface.

In a first step the particles of the first surface are scanned with a Raman spectrometer and a preliminary Raman signal is collected.

The particles are preferably nanoparticles. The term nanoparticles includes but is not limited to at least one or a combination of the following: carbon nanotubes and/or carbon nanofibers and/or carbon nanoplatelets and/or PM 2.5 and/or PM10 and other nanotubes and nanofibers. Said particles are conveyed in a fluid. The term fluid refers preferably to air or any other fluid.

In a second step at least one additional physical property of the particles is determined. The term physical property is to be understood as a property of the particles that is measurable. Preferably a sensor unit is arranged to determine said at least one additional physical property.

In a third step a correction factor is calculated based on the additional physical property.

In a fourth step a final Raman signal is calculated based on the correction factor and the preliminary Raman signal in order to determine the actual mass of the particles.

In a fifth step the actual mass of the particles is determined based on the final Raman signal.

With the consideration of the at least one additional physical property the mass of the particles can be determined with a higher accuracy. This in particular in view of the fact that with the at least one additional physical property, the eventual loss of excitation light of the Raman spectrometer caused by for example particles with a high absorption, particles having a larger size or aggregated particles can be taken into account.

The physical property is preferably an optical property of the particles. In particular the optical property is preferably an absorption property and/or a transmission property and/or any other property related to the interaction of the particles with light as provided by the Raman spectrometer.

Preferably the collection membrane has determined optical properties and wherein said optical property of the particles is determined by collecting the optical property of the particles by a sensor unit which is arranged on the side of the second surface and an optical value is determined. In the third step a correction factor is calculated based on the optical value, and in the fourth step the final Raman signal is calculated based on the correction factor and the preliminary Raman signal in order to determine the actual mass in the fifth step.

Preferably the correction factor is obtained by comparing the measured optical value with a calibrated optical value.

Preferably the relationship between the intensity and the mass and the calibrated optical value are determined by a calibration step, whereby the calibration step comprises:
deposing a determined mass of pure material on first surface of the membrane;
collecting a Raman signal of said determined mass of pure material;
determining the mathematical function that correlates the intensity of the collected Raman signal to the mass for the specific material, and
measuring the optical property of the pure material to obtain said calibrated optical value.

The mathematical function is preferably a linear function whereby the Raman signal is directly proportional to the mass of the pure material. The linear function is preferably defined as follows: Raman Signal=Mass×Constant.

The pure material has preferably the form of evenly dispersed particles. The evenly dispersed particles have the advantage that the absorption of the excitation light is minimized.

Preferably before the third step a comparison is made between the measured optical value and the optical value of the pure material. When the measured optical value is within the range expected for the pure material, the correction factor is set to a value of 1. When the measured optical value is not within the expected range, the correction factor is calculated as the ratio between the measured optical value and the optical value of the pure material.

Preferably the complete surface or an acquisition area or a plurality of acquisition points is scanned.

In the first variant the complete surface of the collection membrane is scanned in the first step and wherein the complete surface of the collection membrane is taken into account to determine the additional physical property.

In a second variant an acquisition area on the surface of the collection membrane is scanned in the first step and wherein the acquisition area of the collection membrane is taken into account to determine the second property. The acquisition covers a part of the whole surface of the membrane.

In a third variant a plurality of acquisition points on the surface of the collection membrane is scanned in the first step and wherein the plurality of acquisition points surface of the collection membrane is taken into account to determine the second property.

Preferably the third step and the fourth step and the fifth are carried out by computer.

The membrane is provided with a material having physical properties allowing light to pass through the membrane from the first surface to the second surface. The membrane is preferably an optically transparent membrane.

A computer program product comprising instructions, which, when the program is executed by a computer, causes the computer to carry out he steps of the method as described herein.

A device to determine the mass of particles collected on a collection membrane, in particular according to a method as described above comprises
a holding structure to hold the collection membrane having a first surface and a second surface, whereby the particles to be analysed are deposited on the first surface,
a Raman spectrometer with a laser configured to scan the particles of the first surface and to collect a preliminary Raman signal,
a sensor unit configured to determine at least one additional physical property of the particles, and
a computer configured to calculate a correction factor based on the additional physical property, and to calculate a final Raman signal based on the correction factor and the preliminary Raman signal in order to determine the actual mass of the particles.

For the determination of the optical property the sensor unit is an optical sensor unit configured to determine an optical property of the particles, wherein the optical sensor is preferably arranged on the side of the second surface of the collection membrane.

### BRIEF DESCRIPTION OF THE DRAWINGS

Preferred embodiments of the invention are described in the following with reference to the drawings, which are for the purpose of illustrating the present preferred embodiments of the invention and not for the purpose of limiting the same. In the drawings,

FIG. 1 shows a first embodiment of a system that is preferably operated by the method as described; and

FIG. 2 a schematic flow diagram of a step of a preferred method.

### DESCRIPTION OF THE INVENTION

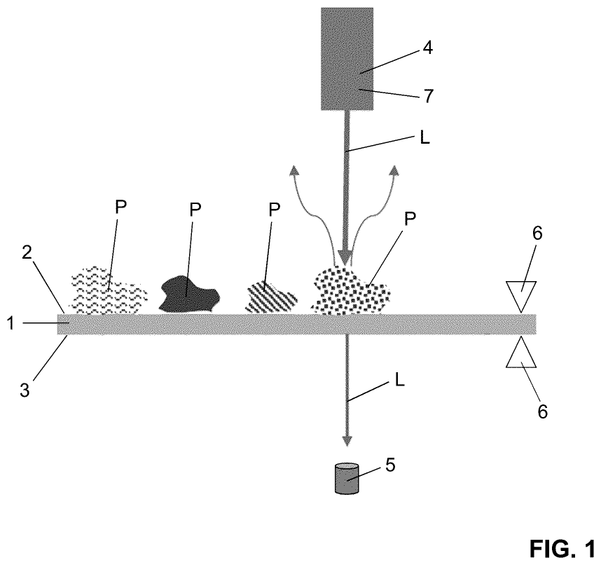

FIG. 1 shows a device to determine the mass of particles P. The device comprises a holding structure 6 that is configured to hold a collection membrane 1. The particles P are collected on a collection membrane 1. The collection membrane 1 has a first surface 2 and a second surface 3. The particles P to be analyzed are deposited on the first surface 2. In order to analyze the particles P, the collection membrane 1 is place into the holding structure.

The device further comprises a Raman spectrometer 4 with a light emitting unit 7 configured to scan the particles P of the first surface 2 and to collect a preliminary Raman signal Rp.

The device further comprises a sensor unit 5 configured to determine at least one additional physical property of the particles P. The additional physical property is additional to preliminary Raman signal Rp or the mass of the particles that is determined based on the preliminary Raman signal Rp. The sensor unit 5 in the embodiment is arranged on the side of the second surface 3 of the collection membrane 1. In the present embodiment the sensor unit is an optical sensor unit 5. The optical sensor unit 5 is configured to determine said additional physical property which is an optical property of the particles P.

The device further comprises a computer that is not shown in the figures. The computer is configured to calculate a correction factor CF based on the additional physical property, and to calculate a final Raman signal Rf based on the correction factor CF and the preliminary Raman signal Rp in order to determine the actual mass of the particles P.

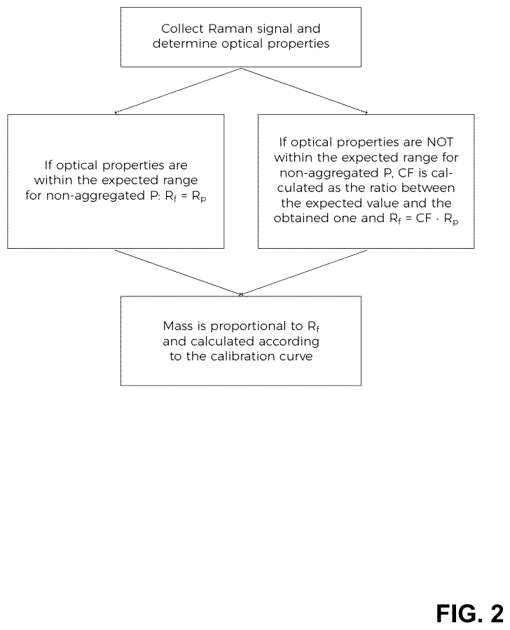

According to the invention, the device is operated by a method as explained in the following. The method could also be executed by a different device. The method is illustrated in FIG. 2. The method serves to determine the mass of particles P collected on the collection membrane 1, whereby the particles P are deposited on the first surface 2. The method comprises the following steps:
In a first step the particles P of the first surface 2 are scanned with the Raman spectrometer 4 and a preliminary Raman signal Rp is collected.
In a second step at least one additional physical property of the particles P is determined.
In a third step a correction factor CF is calculated based on the additional physical property.
In a fourth step a final Raman signal Rf is calculated based on the correction factor CF and the preliminary Raman signal Rp.
In a fifth step the actual mass of the particles P is determined based on the final Raman signal Rf.

The steps are preferably executed in the respective order. The second step is executed after the first step, the third step is executed after the second step, the fourth step is executed after the third step and the fifth step is executed after the fourth step. The third, fourth and fifth step are preferably conducted by a computer and a computer program. In other variants, it may also be possible that some of the steps are performed at the same time. In particular, it may be possible to execute the first and the second step at the same time.

The additional physical property is an optical property of the particles P. This shown in FIG. 1. Light L as emitted from the light emitting unit 7 of the Raman spectrometer is transmitted through the collection membrane 1. The sensor unit 5 measures an absorption property and/or a transmission property and/or any other property related to the interaction of the particles P with light as provided by the Raman spectrometer.

The collection membrane 1 has determined optical properties and said optical property of the particles P is determined by collecting the optical property of the particles P by a sensor unit 5 which is arranged on the side of the second surface 3 and an optical value OV is determined, wherein in the third step a correction factor CF is calculated based on the optical value OV, and wherein in the fourth step the final Raman signal Rf is calculated based on the correction factor CF and the preliminary Raman signal Rp in order to determine the actual mass in the fifth step.

The correction factor CF is obtained by comparing the measured optical value OV with a calibrated optical value COV.

The calibrated optical value COV is determined by a calibration step, whereby the calibration step comprises:
deposing a determined mass of pure material on first side of the membrane;
collecting a Raman signal of said determined mass of pure material;
determining the mathematical function that correlates the intensity of the collected Raman signal to the mass for the specific material, and
measuring the optical property of the pure material to obtain said calibrated optical value COV.

Preferably before the third step a comparison is made between the measured optical value and the optical value of the pure material, wherein if the measured optical value is within the range expected for the optical value of the pure material the correction factor CF is set to a value of 1; and wherein if the measured optical value is not within the expected range of the optical value of the pure material the correction factor CF is calculated as the ratio between the measured optical value and the optical value of the pure material.

Preferably the complete surface of the collection membrane is scanned in the first step and wherein the complete surface of the collection membrane is taken into account to determine the additional physical property. Alternatively, an acquisition area or a plurality of acquisition points on the surface of the collection membrane is scanned in the first step and wherein the acquisition area or the plurality of acquisition points surface of the collection membrane is taken into account to determine the second property.

Preferably, the optical sensor and the Raman spectrometer are arranged in a fixed position with regard to each other. In order to scan the membrane 1, the membrane 1 is moved relative with regard to the optical sensor and the Raman spectrometer.

A computer program product comprising instructions which, when the program is executed by a computer, cause the computer to carry out the steps of the method as described herein.

1. A method to determine an actual mass of particles collected on a collection membrane having a first surface and a second surface, whereby the particles to be analysed are deposited on the first surface,
wherein, in a first step, the particles of the first surface are scanned with a Raman spectrometer and a preliminary Raman signal is collected,
wherein, in a second step, at least one additional physical property of the particles is determined,
wherein, in a third step, a correction factor is calculated based on the at least one additional physical property,
wherein, in a fourth step, a final Raman signal is calculated based on the correction factor and the preliminary Raman signal, and
wherein, in a fifth step, the actual mass of the particles is determined based on the final Raman signal.

2. The method according to claim 1, wherein the at least one additional physical property is an optical property of the particles or at least one optical property of the particles.

3. The method according to claim 2, wherein said optical property is an absorption property and/or a transmission property and/or any other property related to an interaction of the particles with light as provided by the Raman spectrometer.

4. The method according to claim 1, wherein the at least one additional physical property is an optical property of the particles or at least one optical property of the particles,
wherein the collection membrane has determined optical properties and wherein said at least one optical property of the particles is determined by collecting the optical property of the particles by a sensor unit which is arranged on the side of the second surface and an optical value is determined,
wherein, in the third step, a correction factor is calculated based on the optical value, and
wherein, in the fourth step, the final Raman signal is calculated based on the correction factor and the preliminary Raman signal in order to determine the actual mass in the fifth step.

5. The method according to claim 4, wherein the correction factor is obtained by comparing the measured optical value with a calibrated optical value.

6. The method according to claim 5, wherein the calibrated optical value is determined by a calibration step, whereby the calibration step comprises the steps of:
depositing a determined mass of a pure material on the first surface of the membrane;
collecting a Raman signal of said determined mass of the pure material;
determining a mathematical function that correlates an intensity of the collected Raman signal to the mass for the specific material, and
measuring the optical property of the pure material to obtain said calibrated optical value.

7. The method according to claim 6,
wherein, before the third step, a comparison is made between the measured optical value and the optical value of the pure material,
wherein, if the measured optical value is within a range expected for the optical value of the pure material, the correction factor is set to a value of 1; and
wherein, if the measured optical value is not within the expected range of the optical value of the pure material, the correction factor is calculated as a ratio between the measured optical value and the optical value of the pure material.

8. The method according to claim 1, wherein the additional physical property is an optical property of the particles or at least one optical property of the particles,
wherein said optical property is an absorption property and/or a transmission property and/or any other property related to an interaction of the particles with light as provided by the Raman spectrometer,
wherein the collection membrane has determined optical properties and wherein said at least one optical property of the particles is determined by collecting the optical property of the particles by a sensor unit which is arranged on the side of the second surface and an optical value is determined,
wherein, in the third step, a correction factor is calculated based on the optical value, and
wherein, in the fourth step, the final Raman signal is calculated based on the correction factor and the preliminary Raman signal in order to determine the actual mass in the fifth step.

9. The method according to claim 8, wherein the correction factor is obtained by comparing the measured optical value with a calibrated optical value.

10. The method according to claim 9, wherein the calibrated optical value is determined by a calibration step, whereby the calibration step comprises the steps of:
depositing a determined mass of a pure material on the first surface of the membrane;
collecting a Raman signal of said determined mass of the pure material;
determining a mathematical function that correlates an intensity of the collected Raman signal to the mass for the specific material, and
measuring the optical property of the pure material to obtain said calibrated optical value.

11. The method according to claim 10,
wherein, before the third step, a comparison is made between the measured optical value and the optical value of the pure material,
wherein, if the measured optical value is within a range expected for the optical value of the pure material the correction factor is set to a value of 1; and
wherein, if the measured optical value is not within the expected range of the optical value of the pure material, the correction factor is calculated as a ratio between the measured optical value and the optical value of the pure material.

12. The method according to claim 1,
wherein a complete surface of the collection membrane is scanned in the first step and wherein the complete surface of the collection membrane is taken into account to determine the additional physical property; or
wherein an acquisition area or a plurality of acquisition points on the complete surface of the collection membrane is scanned in the first step and wherein the acquisition area or the plurality of acquisition points on the complete surface of the collection membrane is taken into account to determine the second property.

13. The method according to claim 1, wherein the third step and the fourth step and the fifth step are carried out by a computer.

14. A device to determine an actual mass of particles collected on a collection membrane according to a method as claimed in claim 1, the device comprising:
a holding structure to hold a collection membrane having a first surface and a second surface, whereby the particles to be analysed are deposited on the first surface,
a Raman spectrometer with a light emitting unit configured to scan the particles of the first surface and to collect a preliminary Raman signal,
a sensor unit configured to determine at least one additional physical property of the particles, and
a computer configured to calculate a correction factor based on the additional physical property, and to calculate a final Raman signal based on the correction factor and the preliminary Raman signal in order to determine the actual mass of the particles.

15. The device according to claim 14, wherein the sensor unit is an optical sensor unit configured to determine at least one optical property of the particles, wherein the optical sensor is arranged on a side of the second surface of the collection membrane.

16. A device to determine an actual mass of particles collected on a collection membrane, the device comprising:
a holding structure to hold a collection membrane having a first surface and a second surface, whereby the particles to be analysed are deposited on the first surface,
a Raman spectrometer with a light emitting unit configured to scan the particles of the first surface and to collect a preliminary Raman signal,
a sensor unit configured to determine at least one additional physical property of the particles, and
a computer configured to calculate a correction factor based on the additional physical property, and to calculate a final Raman signal based on the correction factor and the preliminary Raman signal in order to determine the actual mass of the particles.

17. The device according to claim 16, wherein the sensor unit is an optical sensor unit configured to determine at least one optical property of the particles, wherein the optical sensor is arranged on a side of the second surface of the collection membrane.

18. A computer program product comprising instructions which, when the program is executed by a computer, causes the device of claim 16 to carry out a third step and a fourth step and a fifth step of a method by a computer,
wherein the method is provided to determine an actual mass of particles collected on a collection membrane having a first surface and a second surface, whereby the particles to be analyzed are deposited on the first surface,
wherein, in a first step, the particles of the first surface are scanned with a Raman spectrometer and a preliminary Raman signal is collected,
wherein, in a second step, at least one additional physical property of the particles is determined,
wherein, in a third step, a correction factor is calculated based on the additional physical property,
wherein, in a fourth step, a final Raman signal is calculated based on the correction factor and the preliminary Raman signal, and
wherein, in a fifth step, the actual mass of the particles is determined based on the final Raman signal.

19. A computer program product comprising instructions which, when the program is executed by a computer, causes the device of claim 16 to carry out a third step and a fourth step and a fifth step of a method by a computer,
wherein the method is provided to determine an actual mass of particles collected on a collection membrane having a first surface and a second surface, whereby the particles to be analyzed are deposited on the first surface,
wherein, in a first step, the particles of the first surface are scanned with a Raman spectrometer and a preliminary Raman signal is collected,
wherein, in a second step, at least one additional physical property of the particles is determined,
wherein, in a third step, a correction factor is calculated based on the additional physical property,
wherein, in a fourth step, a final Raman signal is calculated based on the correction factor and the preliminary Raman signal, and
wherein, in a fifth step, the actual mass of the particles is determined based on the final Raman signal.
